(19) United States
(12) Patent Application Publication
(10) Pub. No.: US 2013/0346112 A1
(43) Pub. Date: Dec. 26, 2013

(54) System and Method of Assisting Fundraisers and Donors

(71) Applicant: Samuel Nixon Chasten, Raleigh, NC (US)

(72) Inventor: Samuel Nixon Chasten, Raleigh, NC (US)

(21) Appl. No.: 13/531,525

(22) Filed: Jun. 23, 2012

(51) Int. Cl. G06Q 40/08; G06Q 40/00

(52) U.S. Cl. 705/4

(57) ABSTRACT

The present invention provides a system and method of assisting fundraising entities and their donors, resulting in the realizing of a novel source of donor funds created by adjusting insurance policies carried by the donors. A third party manager identifies eligible donors, assists with managing the donors' personal and commercial insurance policies, assists with the payment of premiums to insurance companies whereby a surplus in donor funds is realized, and assists with transferring funds from that surplus to the fundraising entity. In a preferred embodiment, there is no cost at all to the donor as well as minimal effort to participate. The invention is preferably executed through an online network.

### FIELD OF THE INVENTION

The present invention relates generally to a system and method of assisting people-supported and membership-based entities with raising funds, e.g., from members, alumni, constituents, contributors, and the like (hereinafter “donors”). The invention relates more specifically to such a system and method in which a third party creates an opportunity for the entity to increase its fundraising by producing a novel source of donor funds created through the optimization of insurance policies carried by the entity's donors, and then by channeling savings resulting from such optimization to the entity.

### BACKGROUND OF THE INVENTION

Fundraising, the process of identifying donors and of soliciting and gathering voluntary contributions from them, is an operation which is vital to countless organizations, particularly to those requiring voluntary donations for their very existence in order to fund even their most basic operations. A wide variety of entities around the world rely on fundraising in one or more manifestations. Those entities range from major universities undergoing improvements to their facilities to small families or even an individual lacking the resources to fund important medical procedures. The list of fundraising entities further includes, e.g., religious organizations, non-profit corporations such as those formed for a social purpose or to engage in medical research, athletic programs, charitable associations and institutions, major corporations raising funds for a charitable purpose, secondary schools, startup ventures, and political campaigns. The list clearly includes a wide variety of types, sizes, purposes, and missions of entities—the foregoing enumerated samples are merely exemplary and are not exhaustive of all such entities.

Many fundraising entities are people-supported, i.e., they raise funds from the general public. Many are also membership-based, as they include a general membership comprising individual people and corporations as part of their operation. A membership-based organization's having a pre-existing list of members, alumni, or constituents is obviously advantageous for fundraising purposes, as such a list reduces the expense and burden of needing first to identify prospective donors. Once prospective donors are identified, fundraising may consist of requesting donations face-to-face, whether at fundraising events, at people's homes, or elsewhere. It also consists of mailing solicitations to the homes and businesses of donors, of purchasing advertising in newspapers or other marketing media, and of including an announcement in a periodic newsletter. Importantly, online fundraising has emerged as a viable alternative in more recent years, partly because of the not insubstantial expense of many of the other methods coupled with shrinking budgets of fundraising entities.

Not unlike fundraising entities, a considerable number of individual donors have unfortunately seen their own budgets tighten in recent years. The ability to donate to the entities and causes which donors wish to support has consequently weakened. Even with the favorable tax treatment of charitable contributions currently allowed, donors have still seen the need to reduce their own annual donations to others. Many donors, nonetheless, maintain a substantial interest in making contributions to others. As a result, it would be advantageous to fundraising entities, and to donors, to provide donors with additional financial incentives for making contributions. It would be particularly advantageous to facilitate the making of a contribution by providing an individual donor with the ability to donate to a desired entity at a reduced cost realized by the donor, preferably at little to no realized cost. It would also be desirable to provide fundraising entities with a means to raise additional funds at little to no expense to them.

U.S. Pat. No. 7,870,067 to Crowl discloses a donation system for encouraging individuals to make small contributions to a charity or political campaign, and for facilitating the giving process, by utilizing a contribution bundler. The system, however, does not reduce the cost of or otherwise provide a financial incentive for making a financial contribution. The system of the invention instead attempts to improve the feasibility of making donations in small sums.

### SUMMARY OF THE INVENTION

The present invention provides many desirable features in connection with the fundraising process. It provides additional financial incentives to donors by reducing the actual cost realized in making a donation using the process of the invention. In a preferred embodiment of the invention, a fundraising entity outlays no funds whatsoever unless and until funds are first received from donors. In a particularly preferred embodiment, and as a particularly advantageous feature of the present invention, donors are able to make financial contributions at no cost whatsoever while simultaneously being able to support the entities and causes they wish to encourage. In addition to making donations at no realized cost, donors may further receive tax incentives by their participation in the process.

The methodology of the present invention combines fundraising with the simultaneous creation of a novel source of donor funds by which to realize funds otherwise unrealized by donors, in turn creating a pool of funds to provide to fundraising entities. The new source of otherwise unrealized donor funds results from the optimization of insurance policies carried by the entity's donors. It is a source of funds that is advantageously both reliable and abundant. It is also largely recession-proof. As an important feature of the invention, the system and method of the present invention incorporate personal and commercial lines of donors' property and automobile insurance policy contracts for realizing funds, and then channels those funds for the purpose of funding desired entities and causes.

In accordance with a preferred embodiment of the invention, the system and method of the present invention may include a third party manager's (1) identifying eligible donors carrying personal and/or commercial insurance policies who wish to contribute to the third party manager's client entity by utilizing the present method, preferably forming a group of participating donors; (2) assisting with managing the donors' personal and commercial insurance policies, preferably including but not limited to the donors' automobile and homeowner hazard insurance policies; (3) assisting with the payment of premiums to insurance companies, whereby a surplus in donor funds is realized; and (4) assisting with transferring funds from the surplus in donor funds to the client entity. The third party manager may manage the system and method of the present invention for many client entities of many types simultaneously. In a particularly preferred embodiment of the present invention, there is no cost at all to the donor as well as minimal effort to participate, while a surplus in the donors' funds is simultaneously realized for the benefit of the fundraising entity. Online fundraising is preferably incorporated into the invention in order to reduce the administrative expense, maximize reach to prospective donors, and increase the methodology's efficiency.

These and other aspects of the foregoing invention will be described in greater detail in the Detailed Descriptions of the Preferred Embodiments.

### BRIEF DESCRIPTIONS OF THE DRAWINGS

For a complete understanding of the above and other features of the invention, reference is made to the following detailed description and the accompanying drawings, wherein:

FIG. 1A is the first part of a flow diagram of a first embodiment of the present invention, utilizing bank trust accounts for maintaining donor funds and a separate entity for both receipt of funds from and disbursement of funds to claimants.

FIG. 1B is the second part of the flow diagram of the first embodiment of the present invention, continued from FIG. 1A.

FIG. 1C is the third part of the flow diagram of the first embodiment of the present invention, continued from FIG. 1B.

FIG. 1D is the fourth part of the flow diagram of the first embodiment of the present invention, continued from FIG. 1C.

FIG. 1E is a block diagram of the first embodiment of the present invention showing bank accounts and the like for executing the invention and demonstrating the transfer of funds among those accounts.

FIG. 2 is a block diagram of a second embodiment of the present invention, utilizing bank trust accounts for maintaining donor funds and disbursing funds to claimants without the separate entity shown in FIG. 2, showing bank accounts and the like for executing the invention and demonstrating the transfer of funds among those accounts.

FIG. 3 is a block diagram of a third embodiment of the present invention, utilizing an in-house method for the disbursement of funds to claimants, showing bank accounts and the like for executing the invention and demonstrating the transfer of funds among those accounts.

FIG. 4 is a block diagram of a fourth embodiment of the present invention, utilizing an online method for the disbursement of funds to claimants, showing bank accounts and the like for executing the invention and demonstrating the transfer of funds among those accounts.

FIG. 5 is a flow diagram of a fifth embodiment of the present invention, utilizing a relationship with a participating bank in connection with the disbursement of funds to claimants, showing bank accounts and the like for executing the invention and demonstrating the transfer of funds among those accounts.

### DETAILED DESCRIPTIONS OF THE PREFERRED EMBODIMENTS

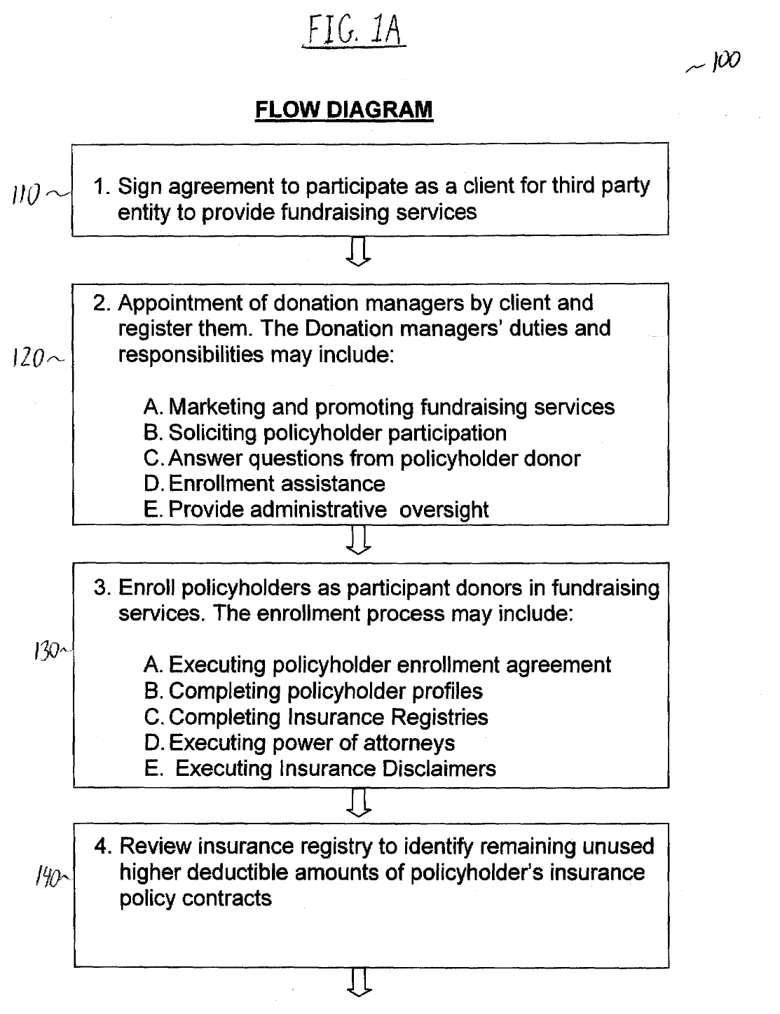

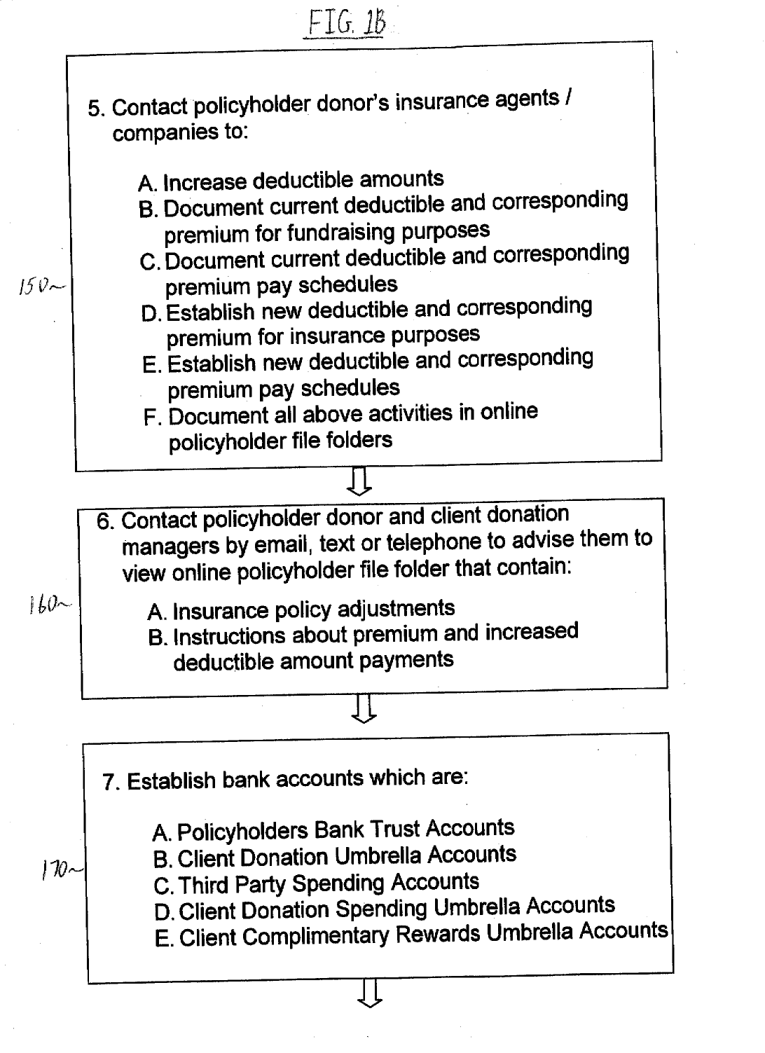

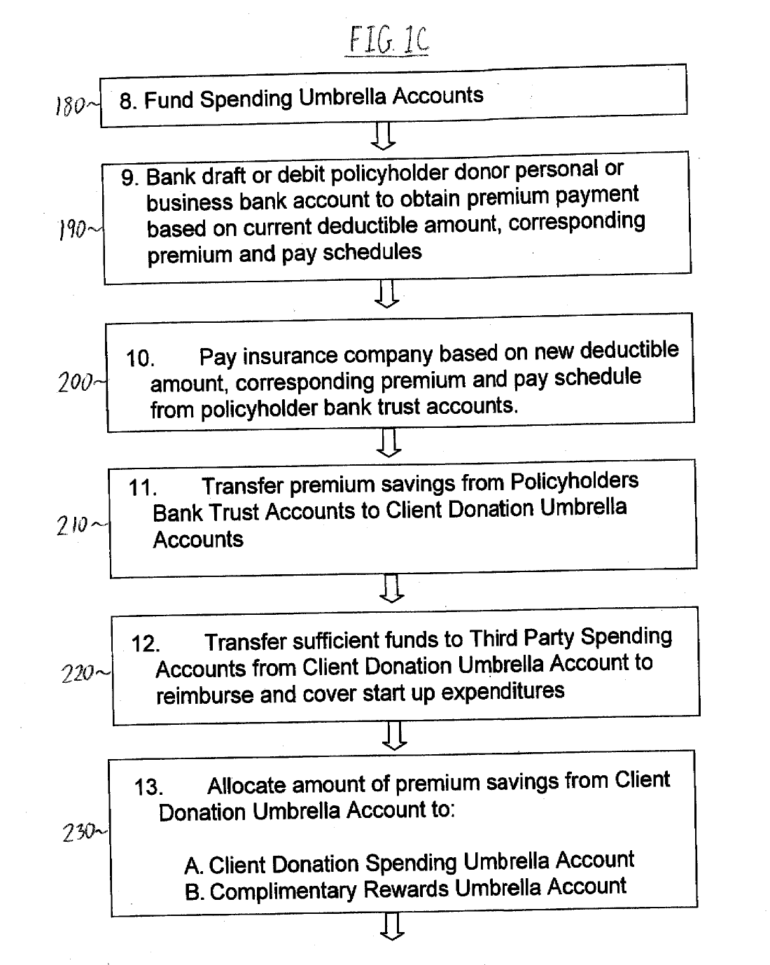

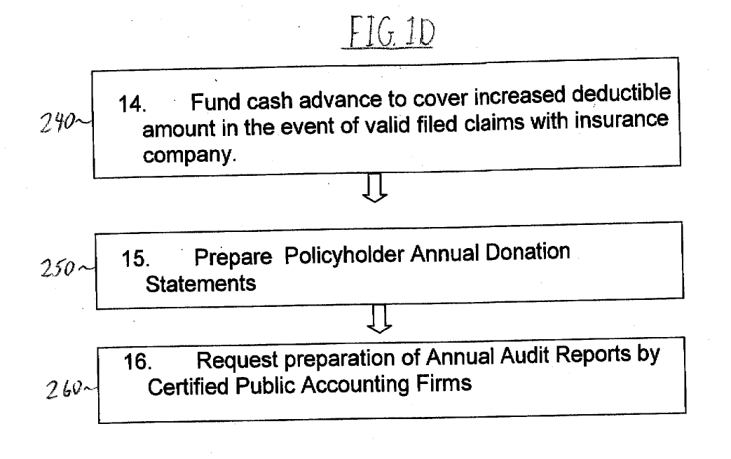

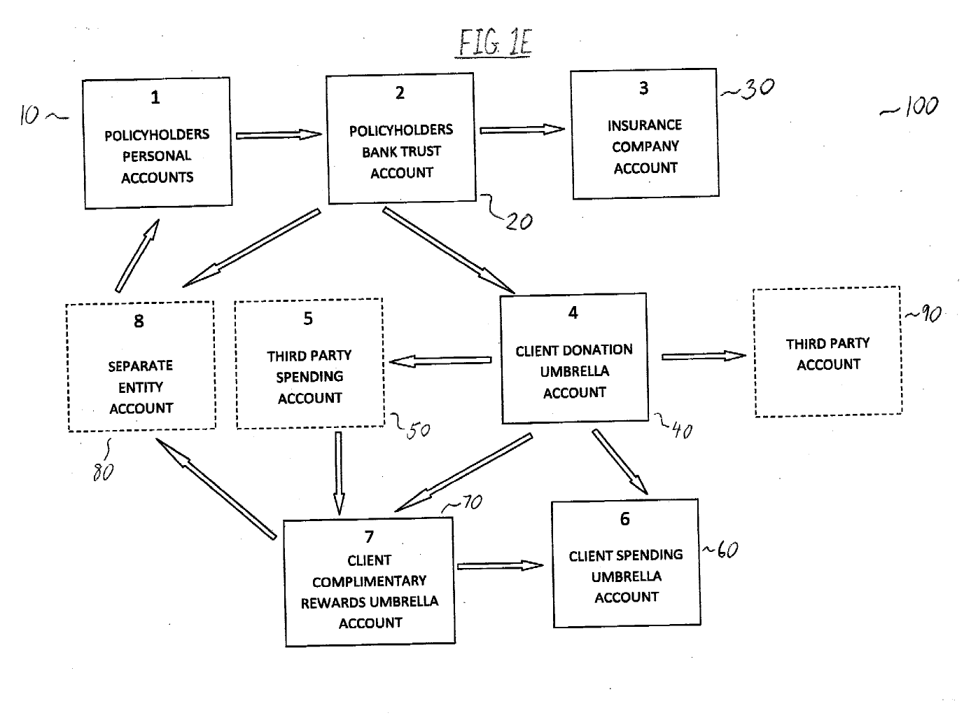

The system and method of fundraising of this invention, which is shown in the flow diagrams of FIGS. 1A through 1D and the block diagram of FIG. 1E and is designated generally by the reference numeral 100 therein, functions to provide assistance to fundraising entities and to donors. More specifically and in accordance with the preferred embodiments of the invention, those fundraising entities, also referred to herein as “clients,” retain a third party firm to assist them with raising funds from donors. As an important feature of the invention, in order to qualify as a donor, an individual or other entity (e.g., a corporate entity) generally must be a party to one or more personal and/or commercial lines of property and/or automobile insurance policy contracts, wherein the other party to the insurance policy contract is an insurance company duly licensed in the jurisdiction in which it operates. For that reason, donors are also referred to herein as “policyholders.” When an event or other loss takes place rendering the insurance company potentially liable for the reimbursement of the policyholder, the policyholder simultaneously acquires the status of “claimant” and may therefore be referenced herein as such. While the third party referenced above is not a required element of the present invention, participation of the third party is generally preferable because the third party advantageously manages the system and method of the invention and operates the online network for the benefit of both the donors and the fundraising entities, creating a more efficient and less expensive system and method for the donors and fundraisers.

As shown generally in FIGS. 1A, 1B, 1C, 1D, and 1E, the system and methodology of the invention 100 includes policyholders, client fundraising entities, insurance companies, and one or more third party managers. Subsequent to an event or other loss in which funds are due from the insurance company to the policyholder, the policyholder simultaneously acquires the status of a claimant. A policyholder executes a power-of-attorney granting the third party manager the authority to transact business with the insurance company on the policyholder's behalf in connection with all matters relating to one or more automobile and/or property hazard insurance policies of the policyholder. With the permission of the policyholder, the third party manager contacts the insurance company and adjusts the amount of the insurance deductible of the policy. Most insurance policies provide the option of selecting one of at least three different deductible amounts. The third party manager requests that the deductible amount be adjusted upwardly, resulting in a reduction in the policyholder's premium. This reduction produces a net savings which otherwise was not realized, and which may be channeled to a client fundraising entity as a donation. To particular advantage, the invention 100 may further provide for a method of channeling funds to the claimant in the event of loss in the amount of the difference between the original (current) deductible amount and the adjusted (new) deductible amount.

More specifically, funds in the amount of the original insurance premium are transferred from a policyholder personal or business bank account 10 to a policyholder bank trust account 20 via bank draft or debit. The policyholder preferably pre-authorizes periodic payments to the policyholder trust account. The funds in the policyholder trust account 20 belong to the policyholders and are managed by the third party manager on behalf of the policyholders. It is the manager's responsibility to transfer insurance premiums to the insurance company accounts 30 in a timely manner. As an important principle of the invention, the premium transferred to the insurance company account 30 is less than the amount of the original premium transferred by the policyholder into the trust account 20.

A sum in the amount of the difference between the original (current) premium transferred by the policyholder 10 and the new (adjusted) premium transferred to the insurance company 30 is placed into a client donation umbrella account 40. Some of the funds are appropriated from the client donation umbrella account 40 to a third party spending account 50 and are used for multiple purposes including administrative functions, e.g., the payment of any required costs for the due filing of documentation relating the power of attorney with appropriate State authorities. A portion of the funds in the client donation umbrella account 40 and in the spending umbrella account 50 is transferred into a client complimentary rewards umbrella account 70, from which funds are transferred to an account 80 maintained by a separate entity which manages those funds for disbursement to policy claimants, into their bank accounts 10, in the event of loss. In such an event, funds are disbursed from the account 80 of the separate entity to the claimant 10, which funds, in addition to proceeds from the insurance company paid directly to the policyholder, compensate the policyholder for any additional deductible amount incurred thereby. Some funds from the client donation umbrella account 40 are conveyed for management expenses. Funds in the client donation umbrella account 40 are then transferred to a client donation spending umbrella account 60, as are unused funds in the complimentary rewards umbrella account 70, where they may be received and used by the client entity. Funds in the client donation umbrella account 40 may also be transferred to a third party manager account 90 to cover management expenses.

As shown in FIGS. 1A and 1E, in a threshold step 110 of the invention, the fundraising entity and third party manager enter into an agreement in which the manager agrees to assist the entity with raising funds. In a second step 120, donation managers are appointed by the client and are registered by the manager for providing assistance and general management in connection with donors. Responsibilities of the donation managers may include, e.g., marketing and promoting fundraising services, soliciting donor participation, answering questions from donors, assisting with enrollment, and providing administrative oversight.

In a third step 130, donors are enrolled to participate in the fundraising method. The enrollment process may include, e.g., executing policyholder enrollment agreements, completion of policyholder profiles insurance information by policyholders, executing powers of attorney which name the third party manager and its agents as attorneys-in-fact for the sole purpose of managing matters relating to donors' designated insurance, and policyholders' executing insurance disclaimers.

In a fourth step 140, the third party manager as well as the policyholders and donation managers, should they desire, review insurance information from the insurance carrier, including but not limited to insurance registry information, to identify unused higher deductible amounts of policyholder insurance contracts.

As shown in FIGS. 1B and 1E, the third party manager contacts agents of the policyholder's insurance carrier in a fifth step 150. The manager, on behalf of the policyholder, effects an increase to the deductible amount and tracks the difference in premiums for fundraising purposes, preferably documenting the change as well as the accumulated savings in online policyholder file folders. In a sixth step 160, the third party manager contacts policyholders and their respective client fundraising entities by email, text message, and/or telephone to advise them to view the online policyholder file folders, containing the insurance policy adjustments and instructions about premium and increased deductible amount payments.

In a seventh step 170, the third party manager establishes bank accounts, including policyholder bank trust accounts, client donation umbrella accounts, third party spending accounts, client donation spending umbrella accounts, and client complimentary rewards umbrella accounts.

As shown in FIGS. 1C and 1E, the manager funds those accounts in an eighth step 180. In a ninth step 190, the premium is obtained by the manager into the policyholder bank trust account from the policyholder via bank draft or debit from the donor's personal or business bank account. The policyholder preferably pre-authorizes periodic payments to the policyholder trust account corresponding to the payment of policy premiums, and the manager duly transfers those funds periodically into the policyholder trust account. In a tenth step 200, the manager pays the insurance premium to the insurance company from the policyholder bank trust account.

In an eleventh step 210, the manager transfers savings from the premium differential from the policyholder bank trust account to the client donation umbrella account. In a twelfth step 220, the manager transfers funds from the client donation umbrella account to the third party spending account sufficient to reimburse and cover startup expenses. In a thirteenth step 230, the manager allocates the amount of premium savings from the client donation umbrella account to both the client donation spending umbrella account and the complimentary rewards umbrella account.

As shown in FIGS. 1D and 1E, in a fourteenth step 240 the manager funds cash advances to cover increased deductible amounts in the event of validly filed claims with the insurance company. In a fifteenth step 250, the manager prepares policyholder annual donation statements. In a sixteenth step 260, the manager requests the preparation of annual audit reports by certified public accounting firms.

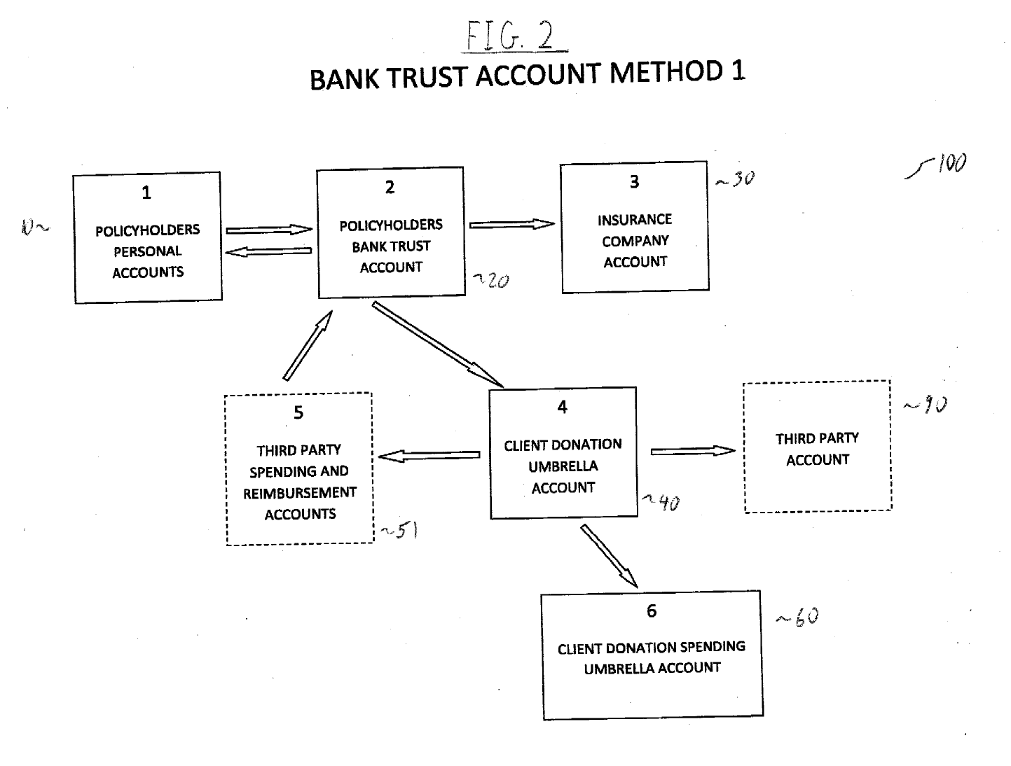

FIGS. 2, 3, 4, and 5 show embodiments of the present invention which are variants of the embodiment described above and shown in FIGS. 1A-E. As shown in FIG. 2, the invention may be implemented without either a separate entity account 80 or a client complimentary rewards umbrella account 70 (shown in FIG. 1E). The embodiment of FIG. 2 uses third party spending and reimbursement accounts 51, which receives funds from the client donation umbrella account 40 and transfers funds back to to policyholders bank trust account. In the event of a loss by a policyholder (e.g., automobile accident, home damage, etc.), funds may then be transferred from the policyholders bank trust account 20 to a policyholder personal account 10.

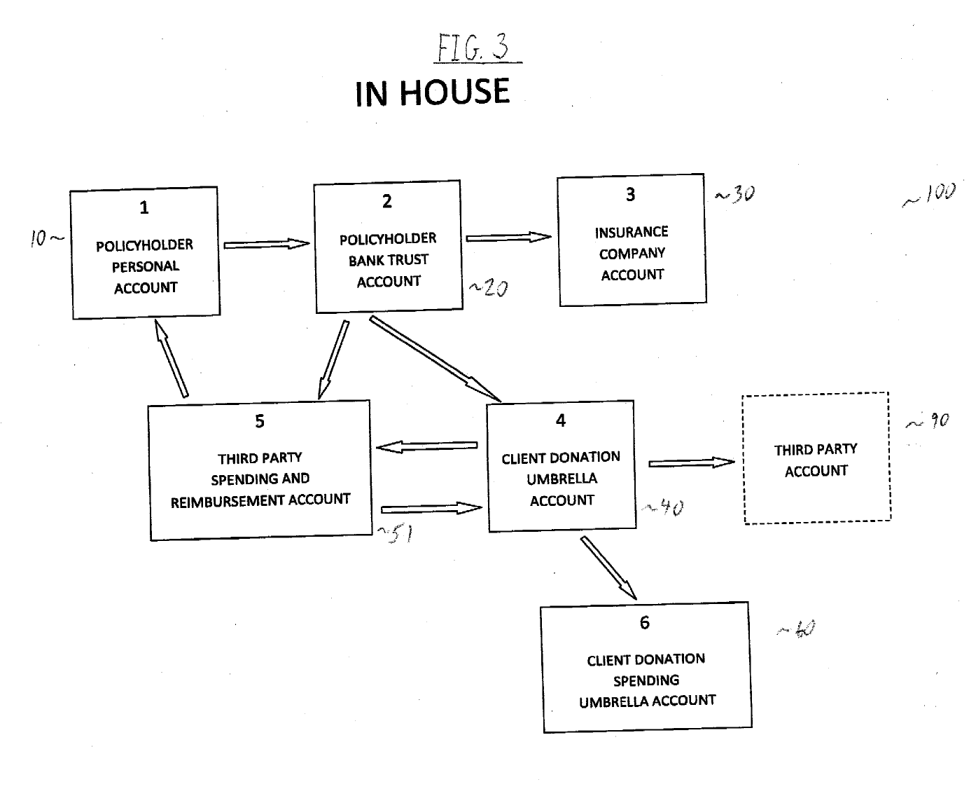

As shown in FIG. 3, the invention shown in FIGS. 1A-E may be implemented with a third party spending and reimbursement account 51 instead of the separate entity account 80, third party spending account 50, and client complimentary rewards umbrella account 70. In the event of a loss by a policyholder, funds may be transferred from the third party spending and reimbursement account 51 to a policyholder personal account 10. Extra funds may also be transferred from the third party spending and reimbursement account 51 back to the client donation umbrella account 40 for the benefit of the client.

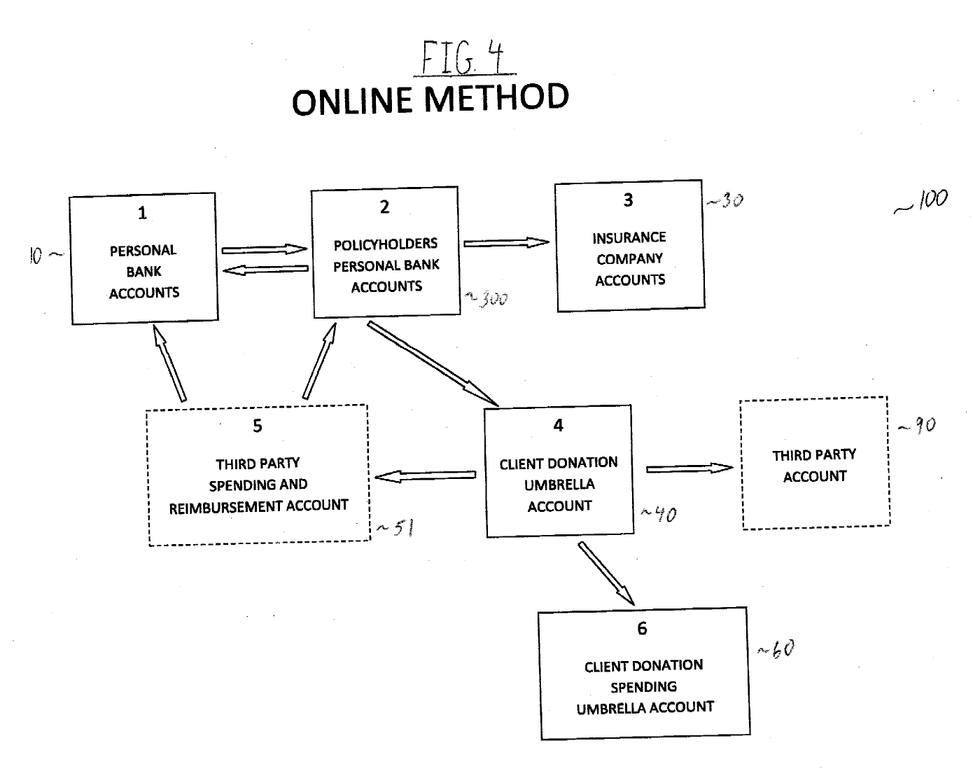

As shown in FIG. 4, the invention shown in FIGS. 1A-E may be implemented as in FIG. 3 but with the policyholder trust account 20 replaced by policyholders' personal bank accounts 300. In addition, funds from the third party spending and reimbursement account 51 are transferred into the policyholders' personal bank accounts 300, rather than from the policyholder bank trust account, and are not transferred back directly into the client donation umbrella account. In the embodiment shown in FIG. 4, it is contemplated that the third party manager is the attorney-in-fact in connection with the policyholder personal bank accounts 300, wherein each policyholder has such an account for the purpose of being managed by the third party for paying insurance premiums and for transferring a surplus into the client donation umbrella account. It is further contemplated that the third party manager may assist each policyholder in establishing such an account.

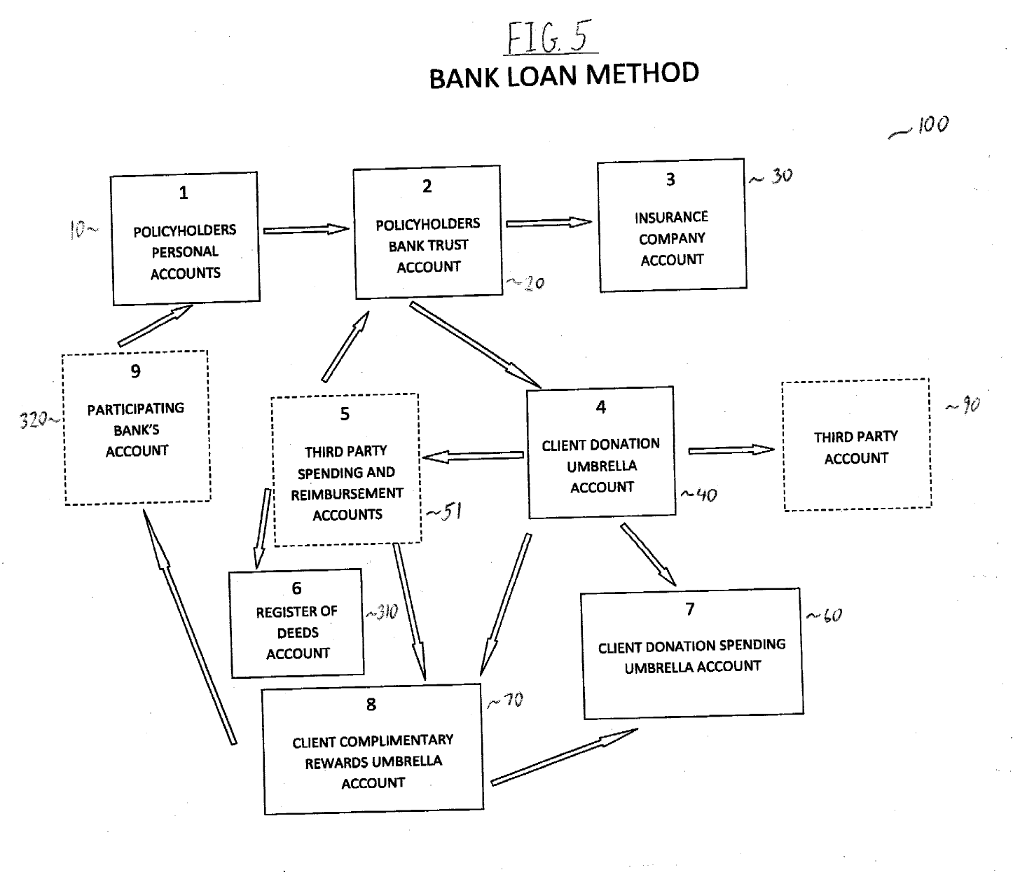

As shown in FIG. 5, the invention may be implemented in a manner in which funds from the third party spending and reimbursement accounts 51 are transferred into the policyholder bank trust account 20 and into a register of deeds account 310 for the payment of any fees associated with duly registering the powers of attorney. In addition, instead of a separate entity account 80, there is an account 320 of a participating bank which may make a loan to a policyholder for the difference in amount between the adjusted and original deductibles in the event of a loss. That loan is repaid with funds from the client complimentary rewards umbrella account 70.

While, in the foregoing, specific embodiments of the present invention have been set forth in considerable detail for the purpose of making a complete disclosure of the invention, it may be apparent to those skilled in the art that numerous changes can be made in such detail without departing from the spirit and principles of the invention.

1. (canceled)

2. The method of claim 21, wherein said insurance policy is an automobile insurance policy.

3. The method of claim 21, wherein said insurance policy is a homeowners hazard insurance policy.

4. The method of claim 21, wherein the method comprises identifying the policyholders, assisting with effecting an adjustment to the deductible of at least one insurance policy of each of the policyholders, and assisting with the payment of at least one adjusted insurance premium of each of said policyholders, whereby a combined surplus of policyholder funds is realized.

5. The method of claim 4, wherein at least one policyholder insurance policy is an automobile insurance policy.

6. The method of claim 4, wherein at least one policyholder insurance policy is a homeowners hazard insurance policy.

7-20. (canceled)

21. A method of facilitating fundraising for a fundraising entity, the method comprising:
receiving payments at a first account from policyholders and accumulating a fund, each of the policyholders having an insurance policy in which a deductible has been increased to a higher level;
transferring a portion of the fund from the first account and paying premiums on the insurance policy;
transferring a remaining portion of the fund from the first account and funding a client umbrella account, the remaining portion being equal to an amount of premium savings recognized by the policyholders;
transferring a first portion of the client umbrella account to a fundraising entity account of the fundraising entity;
transferring a second portion of the client umbrella account to a payment account for paying policyholders that file a claim;
transferring a third portion of the client umbrella account to a third party account for paying expenses encountered during the fundraising;
determining that one of the policyholders has filed a claim on the insurance policy; and
transferring a portion of the payment account to the policyholder that filed the claim to offset the increase in the deductible.

22. The method of claim 21, further comprising transferring a portion of funds remaining in the payment account after a predetermined period to the client umbrella account.

23. A method of facilitating fundraising for a fundraising entity, the method comprising:
funding a first account with payments received from policyholders for an insurance policy, wherein the payments exceed an amount due to an insurance entity for the insurance policy due to an increase in a deductible level of the insurance policy;
transferring from the first account the amount due for the insurance policy;
funding a second account by transferring a remaining portion of the first account to the second account;
transferring a first portion of the second account to a third account controlled by the fundraising entity;
transferring a second portion of the second account to a fourth account, wherein the fourth account serves as a deductible payment pool for the plurality of policyholders;
determining that one of the policyholders has filed a claim on the insurance policy; and
transferring a portion of the fourth account to the policyholder that filed the claim to pay at least a portion of the deductible for the claim and offset the increase in the deductible level.

24. The method of claim 23, wherein the remaining portion of the first account is equal to an amount of premium savings recognized by the policyholders.

25. The method of claim 23, further comprising transferring a third portion of the second account to a third party account to pay expenses encountered during the fundraising.
